(19) United States
(12) Patent Application Publication
(10) Pub. No.: US 2026/0355859 A1
(43) Pub. Date: Nov. 12, 2026

(54) METHOD FOR PROCESSING A BODY

(71) Applicant: Robert Bosch GmbH, Stuttgart (DE)

(72) Inventors: Peter Pfeiffer, Ludwigsburg (DE); Sebastian Wagner, Reutlingen (DE)

(21) Appl. No.: 19/429,189

(22) Filed: Dec. 22, 2025

(30) Foreign Application Priority Data
Dec. 27, 2024 (DE) 10 2024 212 315.3
Dec. 19, 2025 (DE) 10 2025 154 712.2

(51) Int. Cl. B23K 26/08; B23K 26/064; B23K 26/354

(52) U.S. Cl. CPC B23K 26/0876; B23K 26/0648; B23K 26/354

(57) ABSTRACT

A method for processing a body. The body has a first, planar surface region and a further surface region. A device providing electromagnetic waves is provided. The device has an optical unit from which the electromagnetic waves emerge. A surface region is processed using electromagnetic waves. The further surface region has a different orientation than the first, planar surface region. For processing the planar surface region, the optical unit is brought into a position from which the electromagnetic waves impinge on the first, planar surface region. A first angle is set between an optical axis of the optical unit and a perpendicular of the first, planar surface region. For processing the further surface region, the optical unit is brought into a position from which the electromagnetic waves impinge on the further surface region. A second angle is set between the optical axis, and a perpendicular of the planar surface region.

### BACKGROUND INFORMATION

In connection with the manufacture of housings for electronic devices, an adhesive is conventionally used in the joint between the housing parts in order for such a housing created by joining to be as tight as possible. In connection with this so-called polymer-based assembly and interconnection technology, these adhesives are used specifically to provide different functions.

In addition to achieving the aforementioned function of sealing the housing against media such as gases or liquids, components specifically arranged within the housing, for example, can also be cooled down, so to speak, by means of such an adhesive, i.e., these adhesives support the heat dissipation away from such an electronic component.

A further function of such a sealant is to shield other electrical devices from electromagnetic radiation that, emanating from the housing, could affect or impair these other electronic or electrical devices. Furthermore, such an adhesive can make so-called structural bonding of two or more joining partners possible. Such structural bonding creates cohesion between the joining partners so that the joining partners can be treated as a single element. Different adhesive systems are used to fulfill the different tasks. This means that, for example, epoxy resins, polyurethanes or silicones are used for bonding. In order for these adhesives to fulfill their intended task reliably, it is necessary for them to adhere permanently to the surfaces that are important for the sealing function. Such a required long-term durability is influenced by environmental conditions. This includes, for example, fluctuations in temperature, humidity in general, and the various moisture loads that depend on the area of application. The environmental conditions of savannas differ from the environmental conditions at a North Atlantic coast. Thus, when comparing these two regions, the temperature changes per day are significantly different, as is the moisture load in general, i.e., over an entire year, which also applies to chemical dissolution processes of metal. For example, salty air near an ocean can cause significant dissolution damage to such a housing, while the environment of a savanna hardly causes any dissolution damage. Areas where it rains frequently, or where so-called water fording is a realistic scenario as part of normal use, lead to the further challenge of preventing water from entering the housing. For this reason, a good adhesive bond between an adhesive and a surface of the housing or housing part must be ensured. For creating a good adhesive bond, for example, a plastics surface was previously activated by means of a plasma at atmospheric pressure. Metallic surfaces, for example, of housings, were usually treated by means of so-called wet-chemical processes.

Conventional wet-chemical cleaning methods often have only a limited cleaning effect. This means that, for example, the aforementioned organic contaminants cannot be completely removed from the surface of the body to be cleaned. Furthermore, such cleaning only takes place on the surface; when using a non-neutral cleaning agent, a certain cleaning quality can be achieved down to a depth of a few nanometers. In this case, the associated high equipment costs are a disadvantage, for example; in addition, both the procurement and disposal of the cleaning chemicals involve costs. The effect of such chemical cleaning is so incomplete that contaminants in skin directly adjacent to the surface, in particular casting skin or mill scale, of the metal body, can return to the surface of the body through migration via still existing pores or micropores as well as cracks and microcracks that could not be completely cleaned or removed beforehand. This movement of the contaminants, if it occurs at all, is time-dependent. This means that these contaminants can return to the surface after a relatively short time so that, despite applying a sealing compound thereafter and subsequently closing the housing, a tight seal of the housing can only be ensured to a limited extent.

When treating metallic surfaces that exhibit spontaneous passivation properties, as is the case, for example, with aluminum, chromium, nickel, titanium, zinc, and silicon, the aim is to achieve an oxide layer that is as stable as possible, yet also reactive, with minimal residual contamination. These residual contaminations include, for example, residues of organic compounds.

A particular challenge in the processing of metallic surfaces arises especially when their spatial course of the surface can no longer be described by just one plane, but is a surface that truly extends in all three dimensions of space. This includes, for example, sealing surfaces of housings or bodies that can be described, for example, by the known geometries of tongue and groove. In contrast to conventional flat, collar-like sections of housings, the sealing surface of which is thus relatively easily accessible to electromagnetic waves, preferably laser beams, this is only possible, for shapes according to the tongue and groove principle, by means of the usual methods on small surface areas.

Germany Patent Application No. DE 10 2011 075 821 A1 describes heating a body by means of laser radiation and thereby, among other things, cleaning it or melting the surface or contact surface of the body. The body disclosed there is a so-called brake disk, as is typical for modern motor vehicles. Such a brake disk, or rather the surface of the brake disk treated there, is completely flat.

### SUMMARY

According to a first aspect of the present disclosure, a method for processing a body is provided, wherein the body is shaped in such a way that it has a first, planar surface region and that at least one further surface region is formed. Furthermore, a device for providing electromagnetic waves, in particular a laser beam, is provided (energizing by means of electromagnetic waves). This device has an optical unit, in particular a focusing lens, from which the electromagnetic waves emerge, and processes a surface region by means of the electromagnetic waves. The further surface region is shaped in such a way that it has a different orientation than the planar surface region, e.g., it is curved. While the planar surface region can be described, for example, in terms of its orientation by a normal vector, it can be specified for the further surface region, for example, that it has at least one region, the surface of which has an orientation that can be described by a normal vector, wherein the normal vector of the further surface or the further surface region points in a different direction than a normal vector of the planar surface or the planar surface region. Furthermore, it is provided that, for processing the planar surface region, the optical unit of the device for providing electromagnetic waves is brought into a position from which the electromagnetic waves impinge on the planar surface region. In this position, for example a first position, a first angle is set, which is set between a central axis, in particular an optical axis, of the optical unit and a perpendicular (normal vector) of the planar surface region.

According to an example embodiment, for processing the further surface region, the optical unit of the device for providing electromagnetic waves is brought into a position from which the electromagnetic waves impinge on the further surface region, wherein a second angle, which differs from the first angle, is set between the central axis, in particular the optical axis, of the optical unit and a perpendicular of the planar surface region. This changed position can also be referred to as a second position, for example. Such an approach has the advantage that, in order to achieve a well-processed surface for the intended purposes, a relatively large, contiguous, well-processed surface portion results. This greatly increases or extends the time until the corresponding surface is undermined, for example, by dissolution processes of the metal. The corresponding housing part or closed housing is thus protected from environmental influences for a longer time, which especially pertains to the electronic components inside.

The aforementioned processing can, in principle, comprise changing a coating of the surface region or a layer of the surface region. Elements or contaminants that are arranged on or adhere to this surface region can also be removed through this processing. A curvature of the further surface region can be curved inward (concave) or outward (convex).

The shaping of the body can be achieved, for example, by deformation, such as bending, and in particular by deep drawing, for example. The shaping can also be achieved by so-called primary shaping, which comprises, for example, casting, in particular die casting.

The body may, for example, have a partially plate-like region, as is provided for parts of housings, such as housings for motor vehicle control systems, wherein a profile-like region is integrally connected to the plate-like region of the body. Such a profile-like region of the body may, for example, be a rib of the body, which serves, for example, to stiffen the body. A profile-like region of the body may also be a rib that serves a different purpose or possibly a further, additional purpose. For example, such a rib may also be a rib that serves to form, together with a second body (second housing part), a seal or a tight housing by placing a sealant between the one housing part (body, first body) and another housing part (second body, second housing part). The aforementioned profile-like region of the body (first body) can also be referred to as a so-called “tongue,” for example. A typical counterpart to this profile-like region (rib, tongue) may, for example, be a so-called groove of the other body (second body) (“tongue and groove”). The further surface region may, for example, partially have an outer-cylindrical-shell-like shape (e.g., when designed as a tongue). Since the further surface region can also be designed as a so-called groove as part of a surface of a profile-like region of the body, this surface region can also be designed as an inner-cylindrical-shell-like surface or shape. According to this idea of the present disclosure, such a profile-like region, whether formed as a tongue or as a groove, is to extend at least in sections along a so-called profile line. Over the corresponding section of its extension, the profile-like region, whether formed as a groove or as a tongue, has a profile that is congruent (parallel) over a certain length, at least for certain sections, of the profile itself. This direction of extension is a profile line (projection direction). It is provided that an energizing unit, which serves to direct electromagnetic waves onto the surface of the body, is moved along the profile line. This has the advantage that the energizing unit can be guided or moved at a constant distance from the profile, and that the quality of the processed surface or of the processed surface region is thus expected to be rather constant.

In a particularly advantageous example embodiment, it has been shown that a different second angle, which differs from the first angle by an angle between 10° and 40°, is particularly advantageous.

According to a further aspect of the present disclosure, it is intended that the device for providing the electromagnetic waves is used to process both the further surface region and the planar surface region, wherein the optical unit has the same setting, i.e., the same angular setting. This has the advantage that, in this region of the processed body, traversing takes place with only one setting of the optical unit and in only one pass or cycle along the line (travel line), thus eliminating the need for a second cycle or pass through this region. This is a compromise between the achievable acceptable surface qualities and the time required for processing.

According to a further exemplary embodiment, it is provided that a surface region between the further surface region and the planar surface region is not illuminated, at least not directly. Such a non-illuminated surface region is located, for example, in the area of a zone behind a protrusion (tongue or edge element of a groove) and is therefore a shaded region. Such a shaded region is in particular acceptable if this shaded region, which is not processed by the electromagnetic waves, is located in a zone that will be less affected by the environmental conditions or is relatively far away from the external environmental conditions. This region, which is shaded at least with respect to direct radiation, or at least not continuously directly irradiated (due to roughness), is nevertheless illuminated, but not in a consistent, continuous manner: Reflections from other, for example, directly illuminated, surface regions can lead to the illumination of shaded regions. This indirect illumination can lead to cleaning effects on the surface. On surfaces that are particularly strongly indirectly illuminated (and, due to roughness, only very slightly directly, non-consistently illuminated), isolated, non-contiguous surface sections or regions may melt here and there, especially at the roughness peaks where heat dissipation is significantly worse in comparison to the roughness valleys.

According to a further exemplary embodiment, it is provided that remelting surfaces are created in the further surface region (change in state of matter) and that surfaces that are not melted (in particular not continuously melted), i.e., that remain solid (no change in, or preservation of, the state of matter) are illuminated. This apparent disadvantage has the advantage that, as a result, the surface or the further surface region can be selected such that its contiguous processed surface is particularly large, while the non-melted, still solid surface of the further surface region is at a position where this lack of processing does not represent a disadvantage.

According to a further aspect of the present disclosure, it is provided that a surface region between two remelting surfaces of the further surface region is not directly illuminated. This apparent disadvantage leads to the advantage that larger, contiguous surface regions, which were illuminated and, in particular, melted, can be created within the further surface region so that the adhesion effect for sealants there is improved over a significantly larger surface area, while the non-illuminated surface region is at a position where this is less detrimental, i.e., the advantages outweigh the disadvantages.

According to a further aspect of the present disclosure, it is provided that the optical unit causes a circular-like movement of the electromagnetic wave or the energy transfer surface, in particular the laser beam, on the further surface region. This circular-like movement is superimposed on a larger-area, line-like movement, wherein the circular-like movement guides the electromagnetic wave, in particular the laser beam, from the further surface region to the planar surface region and back. Such a design of the method and of the movements of the electromagnetic wave has the advantage that a particularly thorough processing of the surfaces is possible, which, furthermore, is possible in a first or single pass of the processing.

In order to achieve a particularly favorable position of the further surface region on the body, it is provided that the optical unit is pivoted in the direction of an edge of the body in order to set the second angle. For the purpose of setting the device so that the method can be performed accordingly, reference to a planar surface region is provided. It proves particularly advantageous if the planar surface region of the body is formed as a base of a housing part. This allows the housing part, with its base, i.e., the planar surface region, to be brought into a defined position and in a machine, thus making it easy to set the device for performing the method. An alternative, planar surface region of the body may, for example, be a collar of a housing part that is formed accordingly. In this case, a rear side of the collar, i.e., a surface opposite the planar surface region, for example, a parallel surface, can be received in a defined position by the machine.

As indicated above, it can be particularly advantageous if the further surface region is formed as part of a joining contour of the body, in particular as part of the surface region which is designed as a groove or as a so-called tongue.

The further surface region may, for example, be curved outward (convex) or inward (concave) or have regions where inward-curved and outward-curved surface areas alternate. One advantage is that a surface region designed in this way has a larger surface in comparison to a purely straight surface region, which means that the material change processes of the metal in the body last longer.

A particular design of the surface region exists, for example, if it is formed as part of a profile region in order, on the one hand, to create an increased surface against undermining by material-changing, cohesion-breaking effects, and, on the other hand, to improve or increase holding forces between interacting parts.

Furthermore, according to an aspect of the present disclosure, a computer program is provided, which is designed to carry out all steps according to one of the methods of the present disclosure, or that it is programmed in such a way that it carries out a method of the present disclosure when it is executed on a computer. A machine-readable storage medium is provided, on which the computer program is stored, or that the computer program for use in a method is stored thereon. Furthermore, a control unit is designed to carry out all steps of one of the presented methods or method steps, or that it is programmed for use in a method as presented here.

The example embodiments of the present disclosure are explained in more detail with reference to the figures.

### BRIEF DESCRIPTION OF THE DRAWINGS

FIG. 1 shows a plan view of a body, which is designed, for example, as a housing part of an exemplary control unit.

FIG. 2 shows a cross-section through an edge region of the body of FIG. 1.

FIG. 3 shows a further section through a further edge region of the body of FIG. 1.

FIG. 4 shows a further section through a further edge region of the body of FIG. 1.

FIG. 5 shows a movement of an electromagnetic wave or its focal point on a surface of the body, according to an example embodiment.

FIG. 6 shows a processed collar of a body by way of example.

FIG. 7 shows a cross-section through a combination of one body joined with another body.

FIG. 8 shows a cross-section through a combination of one body joined with another body at a different location.

FIG. 9 shows a control unit, which is connected to the device for processing the body 10 by means of a data transmission line or data transmission device.

### DETAILED DESCRIPTION OF EXAMPLE EMBODIMENTS

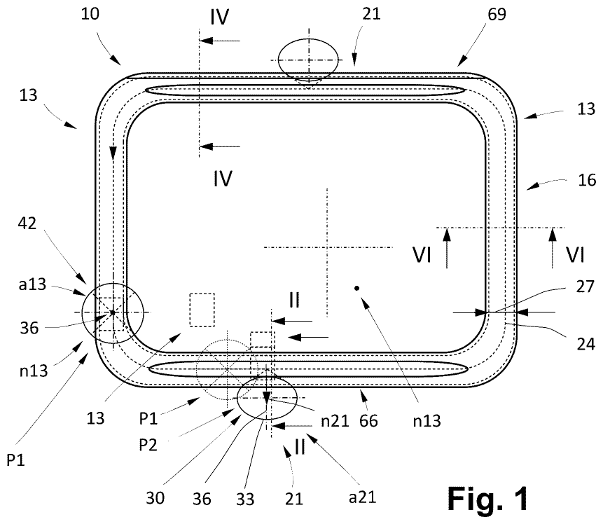

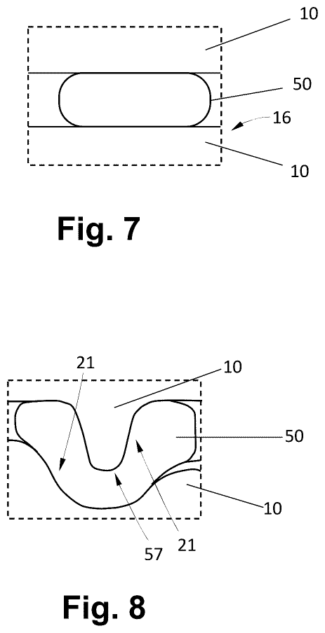

FIG. 1 shows a plan view of a body 10. This body 10 can, for example, be part of a housing of an electronic or electrical device, in particular a control unit for motor vehicles. For example, this body 10 has a planar surface region 13. This planar surface region 13 of the body 10 can be formed, for example, as a collar 16 of a housing part. The collar 16 has a circumferential shape and forms, for example, one or more contact surfaces, via which a connection surface is offered to a further body, which may also be designed as a housing part, for example. For this purpose, a sealing compound can be applied, for example, to the collar 16 or the surface region 13 in order to form a tight joint with a corresponding counterpart of the further housing part (see FIGS. 7 and 8). In addition to this planar surface region 13, there is also a further surface region 21. This further surface region 21 has a different shape than the planar surface region 13. This further surface region 21 serves, for example, to form a structure (assembly of joined parts) in conjunction with another body or the further housing part by means of, for example, a form-fit-like or form-fitting effect or interaction, in which structure, in particular, in addition to an adhesive effect between a body 10, an adhesive seal or sealing compound and a further body, a form component acts between the bodies so that forces can also be exchanged between the bodies through the existing form designs if, for example, adhesive forces between body and seal as well as seal and body fail partially, for example. Such a further surface region can be designed, for example, as a so-called tongue or as a so-called groove, thus providing a possibility of transmitting forces by form fit within the framework of a “tongue and groove connection”. In addition, other form-fitting transmission possibilities for forces are also given, which are described later in this description.

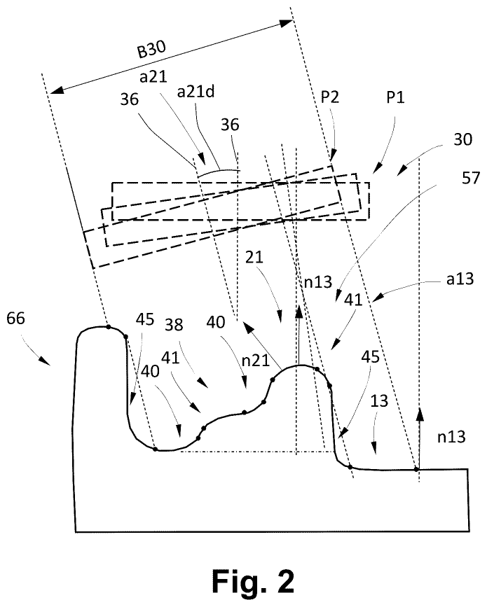

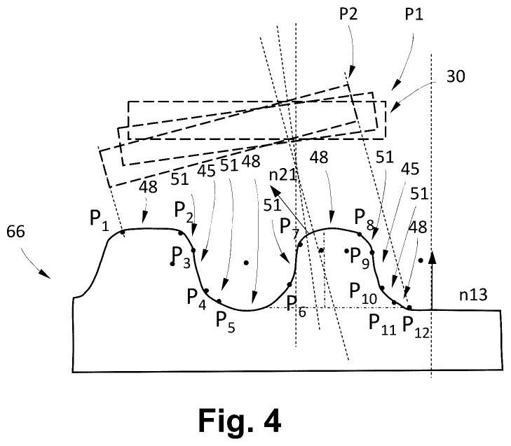

FIG. 1 shows various section indications. Thus, line II-II indicates a section according to the representation according to FIG. 2, and line or marking IV-IV indicates a cross-section through a part of the body 10 according to FIG. 4. Line VI-VI indicates a cross-section as shown in FIG. 6.

FIG. 1 also shows a dashed line 24, which, for example for a processing device, is a kind of travel line for the processing device. The device provided here for processing the body 10 is to be a device that processes the body 10 by means of electromagnetic waves. These electromagnetic waves, in particular in the form of a laser beam, impinge on the surface region 13 and also on the surface region 21 and are typically directed in such a way that they act on the surface regions 13, 21 over a width 27 (working width). Different approaches can be used to guide the provided electromagnetic waves: For example, there is the well-known wobble technique, in which electromagnetic waves are guided in such a way that they cause a circular-like movement of the electromagnetic wave, and in particular its focal point, on the surface region 21. A second, larger-area, line-like movement is superimposed on this circular-like, small-scale movement, wherein this second movement guides the electromagnetic wave(s) along a defined line.

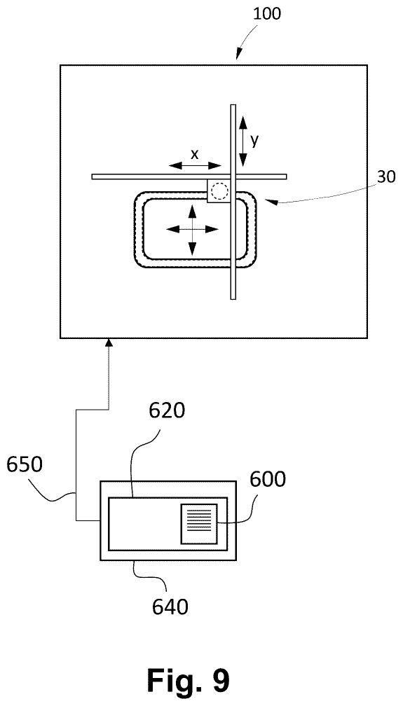

FIG. 1 also shows an optical unit 30 at four different positions in, in principle, two different angular positions. The optical unit 30 can, for example, be a focusing lens 33 from which the electromagnetic waves emerge. The optical unit 30 can have an axis 36, which is, for example, aligned and directed toward the location where the electromagnetic waves, in particular the laser beam, impinge on the surface region 13 or the surface region 21. The axis 36 can also be, in particular, a central axis 36, which can be determined, for example, on mechanical components of the optical unit 30. For example, the focusing lens 33 can have a mechanical, in particular central, axis which is identical to the central axis 36, in particular as an optical axis 36. The optical unit is part of a device 39, which serves to provide the electromagnetic waves 42. The corresponding device 39 is shown in FIG. 9.

FIG. 1 shows that the planar surface region 13 has a specific orientation, which is symbolically represented by a normal vector n13. This normal vector n13 is represented as a point in FIG. 1 since this normal vector n13 points toward the viewer of FIG. 1. See FIG. 2 and the corresponding normal vector n13 for the corresponding planar surface region of the body 10. As can also be seen in FIG. 1, the further surface region 21 has such a shape that it has a different orientation than the planar surface region 13. The orientation shown in FIG. 1, symbolically represented by the normal vector n21 of the further surface region 21, points in a different direction than the orientation of the surface region 13 with the normal vector n13, here exemplified by a point in the center of the optical unit 30. FIG. 1 also shows that the optical unit 30 of the device 39 for providing electromagnetic waves 42 is brought into a position P1 in order, for example, to process the planar surface region 13. This position P1, which can, for example, also be referred to as the first position, is a position from which the electromagnetic waves 42 impinge on the planar surface region 13. FIG. 1 shows by way of example how a first angle a13 is set between the axis 36 of the optical unit 30 and the perpendicular n13 of the planar surface region 13. In FIG. 1, an angle a13 is set for the optical unit 30 and its position P1, which angle is in this example a13=0° to the perpendicular n13 (normal vector). It is preferred that the position P1 of the optical unit 30 and of the axis 36 is “close” to the perpendicular n13 in order to achieve the highest possible efficiency (high energy density/area of the occurring electromagnetic waves). On the other hand, due to possible back-reflection into the optical unit 30, it may be advantageous if the angle a13 differs from 0°.

It is provided that, for processing the further surface region 21, the optical unit 30 of the device 39 for providing electromagnetic waves 42 is brought into a position P2 from which the electromagnetic waves 42 impinge on the further surface region 21. One region of this further surface region 21 is visualized here by a rectangle that can be seen in the plan view. The corresponding position P2, which can also be referred to as the second position, is shown in the lower region of the body 10. For comparison purposes, the position Pl of the optical unit 30 is also shown in this lower region. For comparison purposes, these two positions P1, P2 are shown on the same section of the line 24, which here corresponds to a straight line with the same orientation.

For the position P2, a second angle a21, which differs from the first angle a13, is set between the axis 36, in particular the optical axis, of the optical unit 30 and a perpendicular n13 of the planar surface region 13. The angle a13 in the first position Pl may, for example, lie in a plane that can be defined by two axes: by an axis that runs perpendicular to the line 24 and lies in the plane of the surface region 13, and by the axis perpendicular n13 (normal vector) of the surface region 13. Based thereon, the position P2 can be defined by an angle a21, which lies in this plane defined in this way, see section position II-II.

FIG. 2 shows a representation that corresponds to the sectional view II-II according to FIG. 1. The optical unit 30 is schematically shown here, by way of example, in three different positions.

FIG. 2 shows a further property of the surface region 21. Thus, the surface region 21 shown there has a non-straight, curved curve line 38 (in cross-section, curve profile). This curve line has various curvatures 40, 41. That is to say, in this case, there is a concave curvature 40, which is followed in the direction of a protrusion 57 by both a convex curvature 41 and a concave curvature 40. The curve line 38 finally ends with a further convex curvature 41. This means that the further surface region 21 is partially curved outward and/or partially curved inward.

In the event and assuming that, for example, the planar surface region 13 is irradiated perpendicularly by the device 39 or its optical unit 30, i.e., an angle a13 between an axis 36 of the optical unit 30 and a perpendicular n13 is a13=0°, the differing, second angle a21 is to be set such that it differs from the first angle a13 by an angle a21d between 10° and 40°. FIG. 2 shows the angular range a21d, which in the figure is a difference between the angle a13 and the angle a21, i.e., here a21d=a21. Furthermore, FIG. 2 (symbolically) shows a position of the optical unit 30, which is pivoted the most relative to the perpendicular n13 in comparison to the two other sketched optical units. In this position of the optical unit 30, a different, second angle a21 of fifteen degrees is shown.

As the representations in FIGS. 2, 3, and 4 show, the optical unit 30 has a processing width B30. Within a position P1, P2 occupied by the optical unit 30, the device 39 for providing the electromagnetic waves 42 reaches both the planar surface region 13 and the further surface region 21 so that the device 39 for providing the electromagnetic waves 42 can be used to process both the further surface region 21 and the planar surface region 13. In this case, the optical unit 30 has the same position P2. Due to the processed geometry of the surface of the body 10 in conjunction with the position P2 of the device 39 or its optical unit 30, there may be, for example, not only illuminated surfaces, i.e., surfaces reached by the electromagnetic waves 42, but especially because the optical unit 30 assumes a position P2, which differs from a position P1, where the optical unit 30 is aligned with its axis 36 perpendicular to the surface 13 (plane). Due to this different, second position P2, parts of the entire surface of the body 10 are not illuminated during the processing, i.e., during the method. This non-illuminated region of the surface is here referred to as a surface region 45, which can also be described as a shaded region or a “dark” region. Indirect illumination of these shaded regions is possible, see the explanations given above. Such surface regions 45 can be at various locations of the body 10. This is discussed in more detail with regard to several figures described later. By changing the position P1 of the optical unit 30 to the position P2 in conjunction with the shape of the surface, there are not only fully illuminated surface regions, on which the electromagnetic waves 42 impinge perpendicularly or almost perpendicularly, but also only partially illuminated surface regions 21.

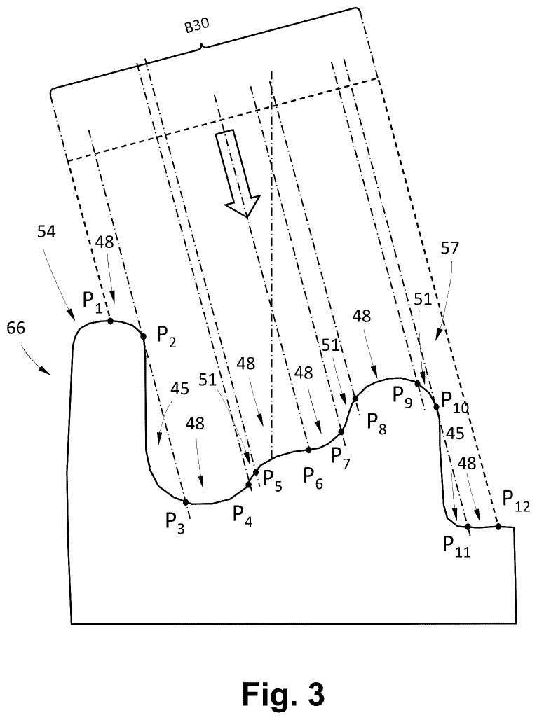

While it is desired that, at the position P2, remelting surfaces 48 are created in the further surface region 21, surfaces 51 that are not melted or remelted, or are not continuously melted or remelted are also illuminated, see FIG. 3. FIG. 3 also shows that, between two remelting surfaces 48 between the points P1 and P2 or P3 and P4, of the further surface region 21, a surface region 45 between the points P2 and P3 is not illuminated. This shaded surface is located directly behind a ridge 54. A further non-illuminated surface mentioned above is located as the surface region 45 behind a protrusion 57 between the points P10 and P11. As FIG. 3 and the surfaces marked there show, there is also a surface 51 (between P4 and P5), which is illuminated but not melted, between remelting surfaces 48 (between P3 and P4 or P5 and P6). Furthermore, for example in FIG. 3, on the right-hand side of the protrusion 57, which is facing away from the optical unit 30, there is a non-illuminated surface, which is marked as the surface region 45. Regarding this surface region 45, it can also be stated that this surface is arranged between two remelting surfaces 48 (P8 and P9 or P11 and P12), wherein one remelting surface 48 (P8 and P9) is in particular directly adjacent to a surface 51 (between P9 and P10), which was not melted but was illuminated.

As FIG. 4 shows, a different contour corresponding to section IV-IV according to FIG. 1 results in similar situations as shown and described in FIG. 3. According to FIG. 4, remelting surfaces 48 as well as non-illuminated surfaces, i.e., shaded surfaces, i.e., surface regions 45 and surfaces 51, which are illuminated but not melted, are present. Regarding the optical unit 30 and its position P2 as well as the angles a21, a13 and aA21d, the same applies as explained for FIG. 2. FIG. 4 shows various surface patterns. For example, two remelting surfaces 48 that are closest to each other are disclosed, between which two surfaces 51 are arranged that are not melted, wherein a further surface, which, as a surface region 45, is a shaded region, is arranged between these two surfaces 51. Furthermore, FIG. 4 shows a surface arrangement in which there is only one surface 51, which is or was illuminated but not melted, between two remelting surfaces 48. The further surface region also has a concave curvature and a subsequent convex curvature, followed by a concave curvature.

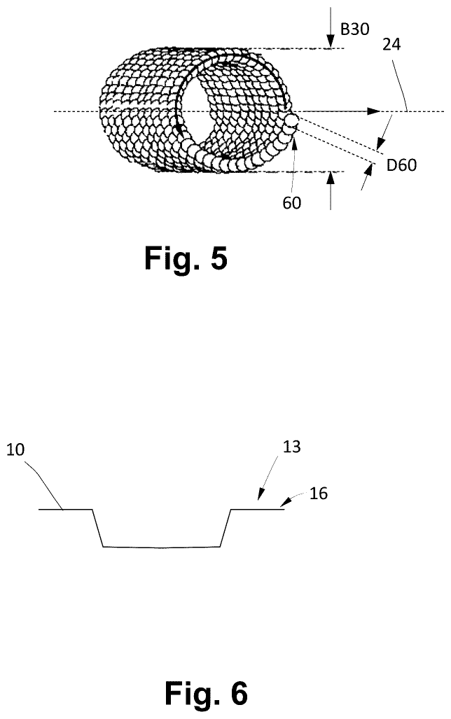

FIG. 5 shows, greatly enlarged, the movement by an electromagnetic wave 42 or the electromagnetic waves 42, in particular a laser beam. As stated above, the device 39 or its optical unit 30 has a processing width B30. Within the framework of this processing width, it is provided that the optical unit 30 causes a circular-like movement 60 of the electromagnetic wave 42, in particular a laser beam, on the further surface region 21. This circular-like movement 60 is a circular-like movement of the energy transfer surface of the electromagnetic waves 42 with a small diameter D60. This superimposition of movements results in a spiral movement overall. The second circular-like movement 63 guides the electromagnetic wave 42, in particular the laser beam, from the further surface region 21 to the planar surface region 13 and back.

FIGS. 1, 2, 3, and 4 show that the body has an edge 66, and the optical unit 30 is pivoted in the direction of the edge 66 in order to set the second angle a21 and thereby assume the position P2.

As FIG. 6 shows, the planar surface region 13 of the body 10 is formed as a collar 16 of a housing part 19 by way of example.

FIG. 7 shows a cross-section through a combination of a body 10 joined with another body 10 (housing part, cover). A seal 50 (in particular sealing compound) is arranged between the body 10, in particular its collar 16, and the other body 10, in particular its collar 16. Such a cross-section can, for example, be at a location as marked by VI-VI.

FIG. 8 again shows, in principle, a cross-section through a combination of a body 10 joined with another body 10 (housing part, cover). There, further surface regions 21, which have a curved curve line, are formed and shown by way of example on both bodies 10. A seal 50, which was brought into its shape shown there by a protrusion 57 of the other body 10, rests against this curve line. The contour 4 the lower body 10 shown in FIG. 8 corresponds to a groove, and the contour of the upper body shown corresponds to a so-called tongue. Both the groove and the tongue are processed according to the method, i.e., as described in the figures above. The further surface region 21 is therefore formed as part of a profile region.

FIG. 9 furthermore shows a control unit 640, which is connected to the device 100 for processing the body 10 by means of a data transmission line or data transmission device 650 in such a way that control of the device 100 is possible via this data transmission device. This control unit 640 is accordingly designed such that all steps of the method can be carried out or that it is programmed for use in a method of this type. For this purpose, the control unit 640 by way of example has a machine-readable storage medium 620, on which a computer program 600 is stored, or on which the computer program 600 for use in one of the methods described here is stored. The computer program 600 is designed such that it can carry out all steps of one of the methods, or that it is programmed in such a way that it can carry out a method as described here, when it is executed on a computer. The optical unit 30 shown in FIG. 9 is moved along the line 24 in the direction of the x-axis and the y-axis by means of the drive shown.

1-18. (canceled)

19. A method for processing a body, wherein the body is shaped in such a way that the body has a first planar surface region and at least one further surface region is formed, and a device configured to provide electromagnetic waves, including a laser beam, is provided, wherein the device has an optical unit including a focusing lens, from which the electromagnetic waves emerge, wherein the further surface region is shaped in such a way that the further surface region has a different orientation than the first planar surface region, the method comprising the following steps:
for processing the planar surface region, bringing the optical unit of the device for providing electromagnetic waves into a position from which the electromagnetic waves impinge on the first planar surface region, wherein a first angle is set between an optical axis of the optical unit and a perpendicular of the first planar surface region; and
for processing the further surface region, bringing the optical unit of the device for providing electromagnetic waves into a position from which the electromagnetic waves impinge on the further surface region, wherein a second angle, which differs from the first angle, is set between the optical axis of the optical unit and a perpendicular of the first planar surface region.

20. The method according to claim 19, wherein the second angle differs from the first angle by an angular range between 10° and 40°.

21. The method according to claim 20, wherein the device for providing the electromagnetic waves is used to process the further surface region and the first planar surface region, wherein the optical unit has a same position.

22. The method according to claim 19, wherein a surface region between the further surface region and the first planar surface region is not illuminated.

23. The method according to claim 19, wherein, in the further surface region, remelting surfaces are created, and surfaces that are not melted or are not continuously melted over an area are illuminated.

24. The method according to claim 23, wherein a surface region between two remelting surfaces of the further surface region is not illuminated.

25. The method according to claim 19, wherein the optical unit causes a circular-like movement of the laser beam on the further surface region, the circular-like movement being superimposed by a line-like movement, wherein the circular-like movement guides the laser beam from the further surface region to the first planar surface region, and back from the first planar surface region to the further surface region.

26. The method according to claim 19, wherein the body has an edge, and the optical unit is pivoted in a direction of the edge to set the second angle.

27. The method according to claim 19, wherein the first planar surface region of the body is formed as a base of a housing part.

28. The method according to claim 19, wherein the first planar surface region of the body is formed as a collar of a housing part.

29. The method according to claim 19, wherein the further surface region is formed as part of a joining contour of the body.

30. The method according to claim 19, wherein the further surface region is curved partially outward and/or partially inward.

31. The method according to claim 30, wherein the further surface region has a concave curvature, and a subsequent convex curvature, followed by another concave curvature.

32. The method according to claim 19, wherein the further surface region is formed as part of a profile region.

33. The method according to claim 19, wherein the electromagnetic waves are generated by a laser beam source.

34. A non-transitory machine-readable storage medium on which is stored a computer program for processing a body, wherein the body is shaped in such a way that the body has a first planar surface region and at least one further surface region is formed, and a device configured to provide electromagnetic waves, including a laser beam, is provided, wherein the device has an optical unit including a focusing lens, from which the electromagnetic waves emerge, wherein the further surface region is shaped in such a way that the further surface region has a different orientation than the first planar surface region, the computer program, when executed by a computer, causing the computer to perform the following steps:
for processing the planar surface region, bringing the optical unit of the device for providing electromagnetic waves into a position from which the electromagnetic waves impinge on the first planar surface region, wherein a first angle is set between an optical axis of the optical unit and a perpendicular of the first planar surface region; and
for processing the further surface region, bringing the optical unit of the device for providing electromagnetic waves into a position from which the electromagnetic waves impinge on the further surface region, wherein a second angle, which differs from the first angle, is set between the optical axis of the optical unit and a perpendicular of the first planar surface region.

35. A control unit configured to perform a method for processing a body, wherein the body is shaped in such a way that the body has a first planar surface region and at least one further surface region is formed, and a device configured to provide electromagnetic waves, including a laser beam, is provided, wherein the device has an optical unit including a focusing lens, from which the electromagnetic waves emerge, wherein the further surface region is shaped in such a way that the further surface region has a different orientation than the first planar surface region, the method comprising the following steps:
for processing the planar surface region, bringing the optical unit of the device for providing electromagnetic waves into a position from which the electromagnetic waves impinge on the first planar surface region, wherein a first angle is set between an optical axis of the optical unit and a perpendicular of the first planar surface region; and
for processing the further surface region, bringing the optical unit of the device for providing electromagnetic waves into a position from which the electromagnetic waves impinge on the further surface region, wherein a second angle, which differs from the first angle, is set between the optical axis of the optical unit and a perpendicular of the first planar surface region.
